(19) United States
(12) Patent Application Publication
(10) Pub. No.: US 2005/0175973 A1
(43) Pub. Date: Aug. 11, 2005

(54) Textbook with supplemental multimedia capability

(76) Inventor: David E. Miller, Fairport, NY (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/772,812

(22) Filed: Feb. 5, 2004

(51) Int. Cl. G09B 5/00

(52) U.S. Cl. 434/317

(57) ABSTRACT

A learning device is disclosed having both a textbook of substantially conventional format and an electronic storage medium to be accessed through a computing device external to the textbook. At least one of the pages or binding of the textbook may include a transmitter which, upon positive actuation by the user, causes a signal to be generated and transmitted to a receiver of the computing device. Upon receipt of the signal, the computing device accesses and displays the additional information stored on the electronic storage medium. The electronically stored information may be accessible through a stand-alone computing device, a server, a web page, or the like. In so doing, the textbook and electronic media can be used in concert with movement between the two resources being seamless to the user.

### FIELD OF THE DISCLOSURE

The present disclosure generally relates to learning devices and, more particularly, relates to textbooks.

### BACKGROUND OF THE DISCLOSURE

Textbooks are ubiquitous tools used in the teaching of most modern curricula. As will be readily understood by any student, most courses are accompanied by a textbook used by the teacher or professor to facilitate learning. The textbooks typically set forth an overall outline for the course which the instructor may follow or which the instructor can use as a supplement to his or her own teaching plan.

Such textbooks are typically provided just as the name would apply. More specifically, the book consists of significant text attempting to teach the reader the subject matter of the course. This may be provided through the form of written lecture, historical perspective, hypotheticals, and the like. Various forms of graphics, pictures, charts and graphs are often also provided to further enhance the instruction capability of the textbook. As is typical, the textbook is set forth in a plurality of chapters trying to parse the overall subject matter into more manageable subsets. With many courses, each chapter is concluded with a number of questions or problem sets providing the student with homework assignments to complete after reading.

Newer textbooks are sometimes provided in a multimedia format wherein in addition to the conventional textbook format, an electronic storage medium is provided as well. This may be provided in the form of a CD-ROM or DVD which the reader is instructed to use in concert with, or supplemental to, the textbook. For example, when a student is reading the textbook, once the reader reaches a specific point in the instruction, the author of the textbook may wish to provide the reader with a video feed indicating a real world application of the material just taught. At that point, the reader sets aside the textbook, and loads the CD or DVD within a suitable player such as a personal computer for viewing of the materials stored thereon as well. While effective, the use of such a multimedia format is somewhat disjointed in that the user must set aside the textbook while the CD or DVD is played. It would therefore be more advantageous if the two were married more completely to make the simultaneous use of both the electronic storage medium and conventional textbook a more seamless operation.

In still further devices, such as that disclosed in U.S. Pat. No. 6,655,586, it is known to embed RF tags within the pages of a book with a transceiver in the cover of the book. When the pages of the books are turned, the presence or absence of the tag is detected and some further function is performed based on a signal of the transceiver being generated. However, the user does not have control of the further function in such a structure. The lights are dimmed, the music is played, etc. regardless of whether the user wishes it to happen. It would therefore be advantageous in facilitating the learning process, if the user were provided with the ability to control the initiation and replay of the further function associated with the book.

### SUMMARY OF THE DISCLOSURE

In accordance with one aspect of the disclosure, a learning device is disclosed which may comprise a plurality of pages, a transmitter, a computing device, and a receiver. The transmitter may be operatively associated with the plurality of pages and transmit a signal when positively actuated by a user. The receiver may be associated with a computer device and receive the signal from the transmitter with the computing device being adapted to display electronic media based on the signal received from the transmitter.

In accordance with another aspect of the disclosure, a method of learning is disclosed which may comprise reading text provided within a hand held book, positively actuating a transmitter provided with the hand held book wherein the actuating step transmits a signal, receiving the signal at a computing device, and displaying electronic media on the computing device based on the received signal.

In accordance with another aspect of the disclosure, a learning device is disclosed which may comprise a plurality of pages, a binding connecting the plurality of pages, a transmitter mounted in one of the plurality of pages and the binding, an actuator mounted in at least one page and connected to the transmitter, and an electronic storage device adapted to be loaded into a computing device having a receiver adapted to receive a signal transmitted by the transmitter. The transmitter may be adapted to transmit a signal when positively actuated by a user.

These and other aspects and features of the disclosure will become more readily apparent upon reading the following detailed description when taken in conjunction with the accompanying drawings.

### BRIEF DESCRIPTION OF THE DRAWINGS

FIG. 1 is a block diagram schematically representing a learning device constructed in accordance with the teachings of the disclosure;

FIG. 2 is a perspective view of a textbook constructed in accordance with the teachings of the disclosure;

FIG. 3 is a plan view of a sample page of the textbook of FIG. 2; and

FIG. 4 is a cross-sectional view of the page of FIG. 3 taken along line 4-4 of FIG. 3.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents following within the spirit and scope of the disclosure as defined by the appended claims.

### DETAILED DESCRIPTION OF THE DISCLOSURE

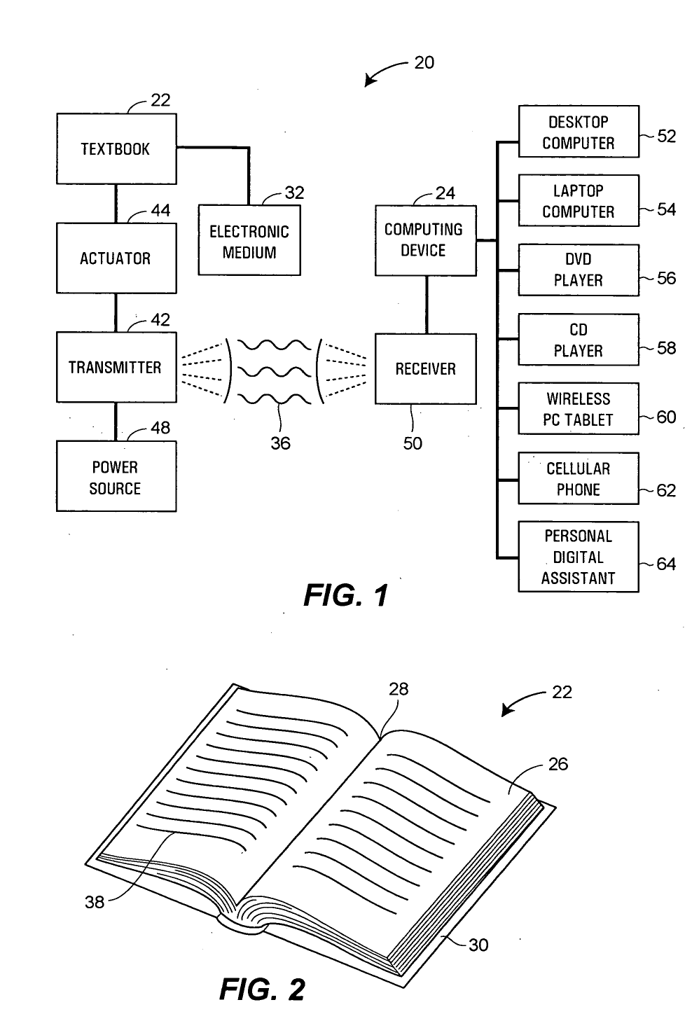

Referring now to the drawings and with specific reference to FIG. 1, a learning device constructed in accordance with the teachings of the disclosure is generally referred to by reference numeral 20. As illustrated therein, the learning device 20 generally includes a textbook 22 and a computing device 24 adapted to communicate wirelessly or by wired connection as will be described in further detail herein.

With respect to the textbook 22, it may include a plurality of pages 26 bound at a spine 28 and protected by an outer cover 30 as illustrated in FIG. 2. Alternatively, while not depicted, it is to be understood that the textbook 22 could be provided in a less formal format including a plurality of loose-leaf pages bound within a three-ring binder or the like, or a plurality of pages simply paper clipped or stapled together.

However, departing from conventional textbooks, the textbook 22 of the present disclosure further provides electronics to allow for the user to positively direct the computing device 24 to play electronic media stored on an electronic storage device or medium 32 sold simultaneously with the textbook. As depicted in FIG. 1, such a storage device 32 may be provided in the form of a compact disc (CD), digital video disc (DVD), or any other form of portable electronic storage media having a solid-state media device for image and storage replay.

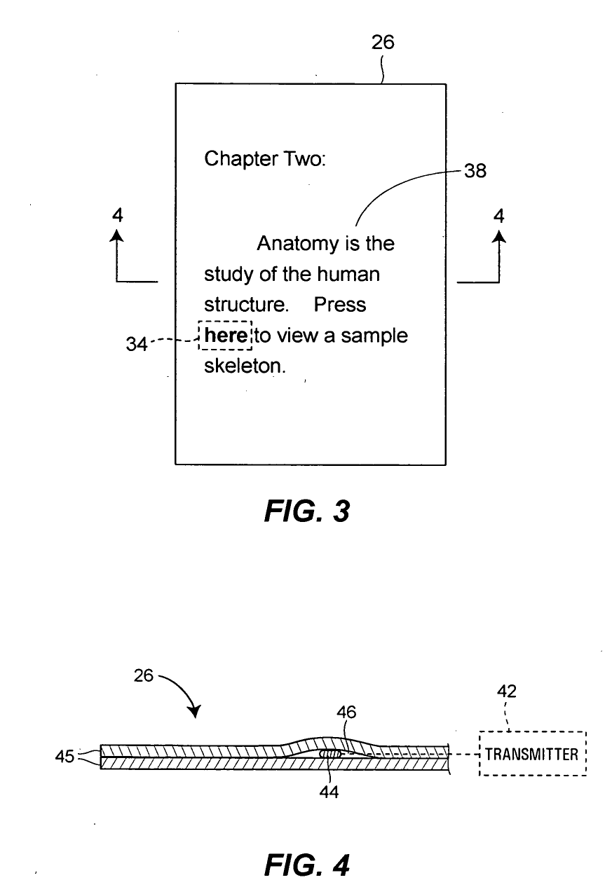

Referring now to FIG. 3, it will be noted that at least one of the plurality of pages 26 could be provided with an actuation block 34 which, upon positive actuation by a user, would cause a signal 36 (FIG. 1) to be transmitted to the computing device 24 for display of the electronic media stored on the storage device 32. As used herein, “positive actuation” is defined as requiring an overt act, beyond simply turning the page, for the user to generate a signal, with such acts including, but not being limited to, depressing an actuator, scanning an actuator, and the like. In so doing, it can be seen that when the user wants to access the supplemental multimedia information of the computing device, he or she must perform an overt act indicative of that want. Importantly, such a system enables the supplemental information to be accessed repeatedly, and at will, by the user.

The pages 26 may include normal text 38, as well as one or more actuation blocks 34. While in the depicted example, the actuation block is displayed as bold text, otherwise high lighted and/or underlined text, as well as any other portion of the page 26 could be made into an actuation zone including, but not limited to, margin notes, section headings, chapter identifications, graphics, charts, graphs, etc. What is important to note is that the actuation blocks or zones 34 are electronically tied to a transmitter 42 for generation of the signal 36 to the computing device 24. For example, as depicted in FIG. 4, the actuation block 34 may be provided in the form of highlighted text disposed directly above an actuator 44 embedded in the page 26 between plies 45 and hard-wired by way of conductor 46 to the transmitter 42. Such an actuator 44 can be provided in any currently known format including pressure sensitive actuators, heat sensitive actuators, voice sensitive actuators, or those having some form of movable component, which upon positive actuation of the user generates the signal 36. In still further embodiments, the actuator 44 may be provided in multiple pieces wherein both are metallic and upon depression by the user, the two metallic components contact one another thereby completing a circuit and causing the signal 36 to be generated. Such an embodiment may require some form of spring biasing to be operable. In a still further embodiment, the actuation zone 40 may include a bar-code or some other identifier without a movable actuator. With such an embodiment, an optical scanner, light pen reader, or the like is positively used such that the reader not only recognizes the bar code, but also then wirelessly transmits a signal corresponding thereto to the computing device 24.

It is also to be understood that, while in the depicted embodiment the transmitter 42 is provided and mounted within the spine 28 of the textbook 22, the actuator 44 may itself include a transmitter 42. In other words, the transmitter 42 and actuator 44 may be provided in the same structure. A benefit of providing a single transmitter 42 is that the textbook 22 could be provided with a vast number of actuators 44 embedded in many, if not all, of the pages 26 with each then being connected by way of individual conductors 46 back to the single transmitter 42. In addition, by providing a single transmitter 42, only a single power source 48 needs to be provided within the textbook 22, whereas if individual transmitters 42 are provided within each actuator 44, each would need to be provided with its own power source, e.g., battery.

Referring again to FIG. 1, the computing device 24 is shown to include a receiver 50 adapted to receive the signal 36 emitted by the transmitter 42. Upon receipt of the signal, the receiver 50 causes the computing device to play the electronic media stored on the storage device 32. More specifically, the computing device 24 includes a processor which upon receipt of the signal 36 at the receiver 50 is caused to execute software enabling the electronic media stored on the device 32 to be displayed on the computing device 24. The receiver 50 and transmitter 42 preferably transmit wirelessly to add to the convenience of the system, but may also be hard-wired together as by a USB connection, high-speed serial data bus, high-speed parallel data bus, or other high-speed electronic wire connection.

To facilitate such operation, the computing device 24 may be provided in any number of different forms including conventional personal computers having a display screen. The processor would be electronically mounted within a central processing unit (CPU) of the computing device and be connected to the display screen. The display screen may be a stand-alone monitor as in a conventional desk top personal computer (PC) or provided in an integral screen such as that provided within a laptop computer and typically provided in a form of a liquid crystal display (LCD) or glass plasma display. Alternatively, the computing device can be any other form of smart computing device 24 including, but not limited to desktop computers 52, laptop computers 54, DVD players 56, CD players 58, wireless PC tablets 60, cellular telephones 62, and personal digital assistants 64.

In addition, the computing device 24 may be provided in the form of a server adapted to receive signals from multiple transmitters 42 and cause the electronic media to be displayed on only the display screen of the user causing the transmitter 42 to be actuated. For example, in a class room setting, a number of students may be reading individual textbooks and while student A may actuate the transmitter 42 provided on page twelve, student B across the room may actuate a transmitter 42 provided on page one hundred. Each of these students is therefore accessing a distinct portion of the electronic media stored on storage device 32 and the learning device 20 would cause the server to display the desired portion of the teaching plan on the display screen of the individual student. In so doing, simultaneous instruction can be accomplished.

Each computing device 24 further includes a mechanism by which the storage device 32 can be read such as, but not limited to, digital video disc players, and compact disc players employing laser/optical readers. Consistent with the foregoing example, in a typical classroom setting, individual electronic media playing devices need not be provided, but a single player capable of storing multiple storage devices such as a conventional CD tower or DVD carousel can be utilized to facilitate operation and keep manufacturing costs at a minimum.

In a still further embodiment or alternative, the multimedia information which is to be accessed by the student need not be provided on electronic storage medium sold in concert with the textbook, but rather can be stored on a hard drive or disc drive of the server itself such that, upon actuation of the transmitter 42 by the user, the server accesses that portion of the media stored on the computing device 24 and in turn causes such information to be displayed on the display screen of the individual user.

In a still further embodiment, the additional material may not even be provided on the hard drive of the computing device, but rather can be accessible through an Internet accessible website wherein the computing device 24 simply accesses the desired website storing information to be accessed and transmits same to the computing device 24 and in turn to the display screen.

In operation, it can therefore be seen that the learning device of the present disclosure can be employed by a user reading the textbook and, upon coming to a portion of the textbook or lesson plan having additional supplementary information to be accessed through an external storage device, can positively actuate that portion of the page to access same. By positively actuating that portion of the page, a signal is generated and transmitted to a receiver of the computing device. Upon receipt of the signal, the computing device can access and display the additional information for viewing by the user. As the signals are transmitted automatically by wireless or wired means upon actuation of the transmitter, the user need not set aside the textbook to view the additional information, but rather can view both in concert thus facilitating and expediting the learning process. Moreover, by requiring positive actuation, the user is given greater control over the process including the ability to repeat and/or restart the supplemental information as many times as desired.

1. A learning device, comprising:
a plurality of pages;
a transmitter operatively associated with the plurality of pages, the transmitter transmitting a signal when positively actuated by a user;
a computing device; and
a receiver operatively associated with the computing device, the receiver receiving the signal from the transmitter, the computing device adapted to display electronic media based on the signal received from the transmitter.

2. The learning device of claim 1, wherein the plurality of pages are bound together by a binding, the transmitter being embedded in the binding.

3. The learning device of claim 1, wherein the transmitter is embedded in one of the pages.

4. The learning device of claim 1, wherein more than one transmitter is operatively associated with the plurality of pages.

5. The learning device of claim 1, wherein the transmitter is operatively associated with a plurality of actuators, the plurality of actuators extending into the plurality of pages.

6. The learning device of claim 5, wherein the plurality of actuators are embedded in the plurality of pages.

7. The learning device of claim 1, wherein the computing device is selected from the group of computing devices consisting of CD players, DVD players, desktop computers, laptop computers, personal digital assistants, wireless PC tablets and cellular phones.

8. The learning device of claim 1, wherein the computing device is web enabled.

9. The learning device of claim 1, wherein the transmitter and receiver transmit and receive wirelessly.

10. The learning device of claim 1, wherein the transmitter and receiver transmit and receive over a wired connection.

11. The learning device of claim 1, wherein the transmitter is an optical scanner with wireless transmission capability.

12. The learning device of claim 1, wherein each actuator is disposed proximate to a margin note.

13. The learning device of claim 1, wherein each actuator is disposed proximate to text within the book.

14. A method of learning, comprising:
reading text provided within a hand-held book;
positively actuating a transmitter provided within the hand-held book, the activating step transmitting a signal;
receiving the signal in a computing device; and
displaying electronic media on the computing device based on the received signal.

15. The method of learning of claim 14, wherein the positively actuating step involves depressing an actuator operatively associated with the transmitter and provided within the book.

16. The method of learning of claim 15, wherein the actuator is embedded in a page of the book.

17. The method of learning of claim 15, wherein the actuator is embedded in a binding of the book.

18. The method of learning of claim 14, wherein the transmitting and receiving steps are performed wirelessly.

19. The method of learning of claim 14, wherein the transmitting and receiving steps are performed across a wired connection.

20. The method of learning of claim 14, wherein the displaying step involves using a computing device selected from the group of computing devices consisting of DVD players, CD players, desktop computers, laptop computers, personal digital assistants, wireless PC tables, and cellular phones.

21. The method of claim 14, further including the step of repeating the positively actuating step.

22. A learning device, comprising:
a plurality of pages;
a binding connecting the plurality of pages;
a transmitter mounted in one of the plurality of pages and the binding, the transmitter being adapted to transmit a signal when positively actuated by a user;
an actuator mounted in at least one page and connected to the transmitter; and
an electronic storage device adapted to be loaded into a computing device having a receiver adapted to receive a signal emitted by the transmitter.

23. The learning device of claim 22, wherein the actuator is selected from the group of actuators consisting of pressure-sensitive actuators, heat-sensitive actuators, touch-sensitive actuators, voice-sensitive actuators and electrical contact actuators.
